(19) United States
(12) Patent Application Publication
(10) Pub. No.: US 2011/0265169 A1
(43) Pub. Date: Oct. 27, 2011

(54) USER-DEPENDENT CONTENT DELIVERY

(75) Inventors: Markus BAUER-HERMANN, Aicha vorm Wald (DE); Gerald MEYER, Puchheim-Bhf (DE); Robert SEIDL, Konigsdorf (DE)

(73) Assignee: NOKIA SIEMENS NETWORKS OY, Espoo (FI)

(21) Appl. No.: 13/130,908

(22) PCT Filed: Dec. 30, 2008
(86) PCT No.: PCT/EP2008/068338

§ 371 Date: Jun. 14, 2011

(51) Int. Cl. H04L 9/32; G06F 15/16

(52) U.S. Cl. 726/7; 709/203

(57) ABSTRACT

A gateway is provided between an application and a server. The gateway is used to modify content sent from the server to the application via the gateway. The modification may include adding, removing or modifying content. The modification process is user-dependent and an identity management system is used for identifying the user.

The present invention is related to the field of identity management and the provision of user-dependent content.

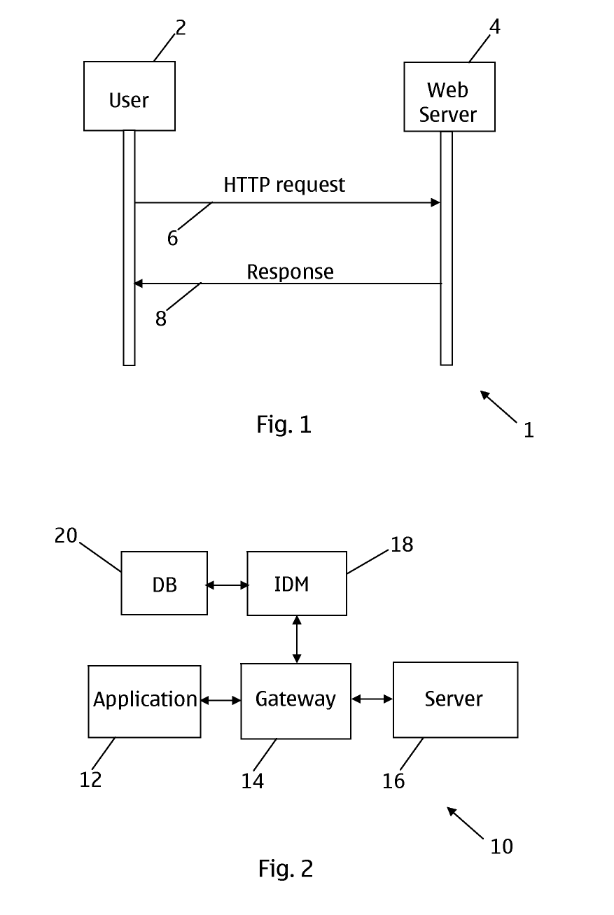

The content of web pages often consists of static and dynamic parts. Dynamic web page content is typically generated at the time at which an HTTP (or HTTPS) request is received from a web browser. FIG. 1 shows a simple mechanism by which a user (for example using a web browser) can access a web server.

FIG. 1 shows a message sequence, indicated generally by the reference numeral 1, showing the transfer of messages between a user 2 and a web server 4. The message sequence 2 shows the issue of an HTTP Request 6 by the user 2 to the web server 4. In response to the HTTP Request 6, the web server 4 constructs a response, which response is sent from the web server to the user as message 8.

The message 8 may take the form of a web page. As noted above, such web pages may include static and dynamic parts, with the dynamic parts being generated at the time at which the request 6 is processed by the web server 4. The dynamic parts of the web page may depend on numerous parameters, such as the time and date, the latest updates of a content management system at the web server 4, the content of any cookies at the user 2, the Internet Protocol (IP) address of the user etc.

For some applications it would be advantageous to be able to identify the user 2 and to tailor the content of the response 8 to the user. One exemplary application for which this would be useful is user-specific advertising, but there are many other applications for which such a feature would be useful. Further examples of such applications are discussed below.

The present invention seeks to address at least some of the problems outlined above.

According to an aspect of the invention, there is provided a method comprising: receiving content from a server, which content is intended for an application; modifying said content depending on the identity of a user of the application; and forwarding the modified content to said application. The method may further comprise determining (or verifying) the identity of a user of the application. The identification of the user may include checking credentials supplied by the user. The application may, for example, be a web server.

According to another aspect of the invention, there is provided an apparatus (such as a gateway) comprising: a first input for receiving content from a server, which content is intended for an application; a module for modifying said content depending on the identity of a user of said application; and a first output for forwarding the modified content to said user. The apparatus may include a module for identifying the user. The apparatus may include a second input for receiving information identifying the user from the application.

According to a further aspect of the invention, there is provided an apparatus (such as a gateway) comprising: means for receiving content from a server, which content is intended for an application; means for modifying said content depending on the identity of a user of the application; and means for forwarding the modified content to said application. The apparatus may further comprise means (such as an identity management system) for determining (or verifying) the identity of the user of the application. The identification of the user may include checking credentials supplied by the user.

According to a further aspect of the invention, there is provided a computer program comprising: code for receiving content from a server, which content is intended for an application; code for modifying said content depending on the identity of a user of the application; and code for forwarding the modified content to said application. The computer program may further comprise code for determining (or verifying) the identity of the user of the application. The computer program may be a computer program product comprising a computer-readable medium bearing computer program code embodied therein for use with a computer.

According to another aspect of the invention there is provided a computer program product comprising: means for receiving content from a server, which content is intended for an application; means for modifying said content depending on the identity of a user of the application; and means for forwarding the modified content to said application. The computer program product may further comprise means for determining (or verifying) the identity of the user of the application.

Thus, the present invention enables content provided by a server to be tailored specifically for a user of a particular application.

The content may be modified by adding material to the content. The added material may be user-dependent. For example, the added material may be advertising that is targeted to the user. The added material may be obtained from a separate server; for example, in the event that the added material is advertising material, the added material may be obtained from an advertising server.

The content may be modified by removing material from the content. For example, the user may specify particular types of content that he does not wish to receive. Alternatively, or in addition, the user may be prevented from being able to receive certain content, for example for parental control or censorship purposes. Thus, the present invention can be used to enable a user, a service provider and/or a third party to define unwanted material that should not be provided to the user.

The content can take a variety of different forms. By way of example, the content may be web content, such as a web page, Internet protocol television (IPTV) content, or Internet radio content. Of course, many other types of content could be used with the present invention.

The nature of the modification of the content may be under the control of one or more of the user of the application, the server and a third party. For example, the user may be able to determine types of content that should be delivered and/or types of content that should not be delivered, thereby providing a filtering arrangement. Alternatively, or in addition, a third party may specify types of content that should be delivered and/or types of content that should not be delivered, thereby providing a censorship arrangement, for example for the purposes of parental control.

The invention may include determining the identity of a user of the application. The determination of the identity of the user may include the use of an identity management system. For example, the identification of the user may include receiving credentials (such as a username/password pair, fingerprint data, or some other method) from a user and forwarding those credentials to the identity management system for verification. The apparatus in accordance with the invention may include an output for providing the credentials received from the user to the identity management system. The apparatus in accordance with the invention may include a further input for receiving user credentials from the identity management system.

The use of an identity management system provides a mechanism by which a user can be precisely identified. This is preferable in many circumstances to the use of other known identification methods, such as the use of cookies or IP address history tracking, which are less accurate as they do not clearly and indubitably identify a certain user and more prone to error (either accidentally or deliberately). A variety of different identity management systems could be used with the present invention. The preferred embodiments of the invention, however, make use of identity management systems that clearly identify the user, without recourse to guesswork (albeit intelligent guesswork).

Exemplary embodiments of the present invention are described below, by way of example only, with reference to the following numbered drawings.

FIG. 1 shows a known message sequence;

FIG. 2 is a block diagram of a system in accordance with an aspect of the present invention;

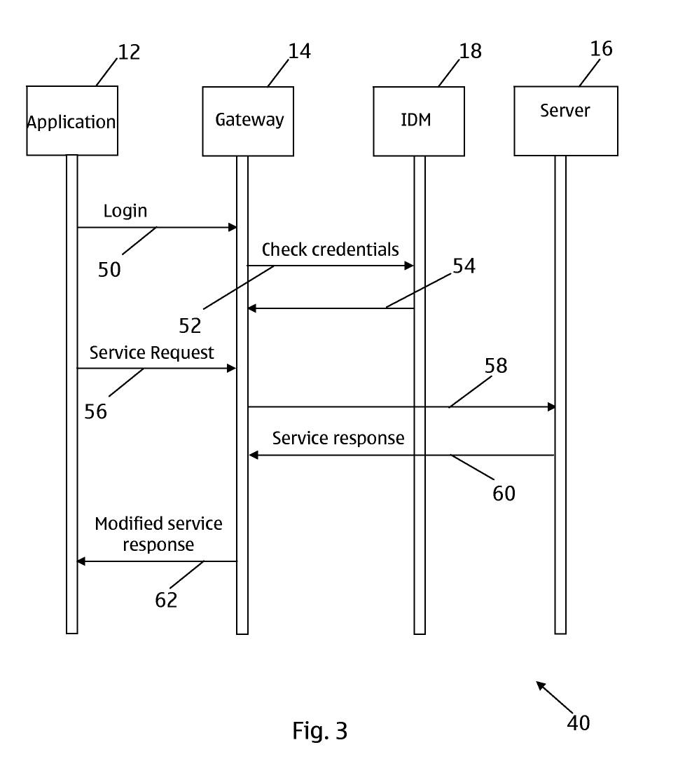

FIG. 3 shows a message sequence demonstrating an exemplary use of the system of FIG. 2; and

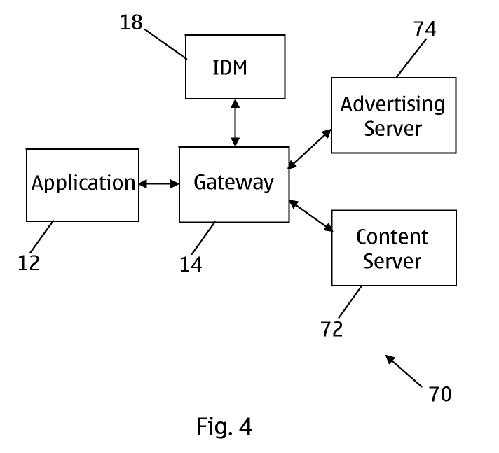

FIG. 4 is a block diagram of a system in accordance with an aspect of the present invention.

FIG. 2 is a block diagram of a system, indicated generally by the reference numeral 10, in accordance with an aspect of the present invention. The system 10 comprises an application 12, a gateway 14, a server 16, an identity management (IDM) system 18 and a database 20. In one form of the invention, the application 12 is a web browser and the server 16 is a web server. The application 12 is typically under the control of a user.

The gateway 14 is a software or hardware gateway that is adapted to inspect packages and modify them according to certain principles, as discussed further below. In particular, as discussed in detail below, the gateway 14 is adapted to modify messages sent from the server 16 to the application 12 via the gateway, with the modification being dependent on the identity of the user of the application 12.

The identity of the user is determined (or verified) by the IDM 18. When a user of the application 12 connects to the gateway 14, that user may be identified by the IDM 18 using one of a number of mechanisms (e.g. SIM AKA username/password, fingerprint detection etc.), in a manner well known in the art. The gateway 14 and the IDM 18 may have a secured connection (e.g. SSL or TLS).

As shown in FIG. 2, the IDM 18 may make use of the database 20, which database may, for example, be an LDAP or Radius database. In some forms of the invention, the database 20 is omitted.

FIG. 3 shows a message sequence, indicated generally by the reference numeral 40, showing an exemplary use of the system 10. The message sequence 40 shows the flow of messages between the application 12, the gateway 14, the IDM 18 and the server 16.

The messages sequence 40 starts with a user at the application 12 logging in to the gateway 14 (message 50). The message 50 includes user credentials and the gateway forwards those user credentials to the IDM 18 (message 52). The IDM 18 checks the user credentials (for example by comparing supplied credentials with credentials stored in the database 20) and, if the supplied user credentials are correct, verifies the identity of the user (message 54). The user then does not need to repeat the login procedure until after the user has logged out.

The credentials provided for the login procedure and the means by which those credentials are checked could take many different forms. For example, the user may simply provide a username/password pair or make use of a hardware dongle, fingerprint reader, voice recognition system or some other apparatus. Many other suitable forms will be known to persons skilled in the art.

With the user of the application 12 logged in to the gateway 14, the application issues a service request 56. The service request 56 may, for example, be an HTTP request that requests access to a web page at the server 16. The service request 56 is sent from the application 12 to the gateway 14. The gateway 14 forwards the request 56 to the server 16 (message 58) and the server 16 returns the requested content to the gateway (message 60).

The gateway 14 is able to inspect and modify content received from the server 16 and forwards a modified service response to the application 12 (message 62). The modification performed by the gateway 14 is based on rules which are stored in the identity management system 18. In particular, the gateway 14 is able to modify and/or add content in the direction of the application 12 (and hence in the direction of the user of that application).

By way of example, data packets sent by the server 16 may be modified, replaced, filtered or even blocked by the gateway so that the response will contain new and/or modified content for the user. This enables user-dependent content to be provided, thereby enabling the delivery of personalised services such as personalised advertising, personalised server functionality (e.g. personalised content of web pages), and role-based content provisioning (e.g. parental control, role of user or administrator, censorship etc.).

For example, if the application 12 is a local email client, the gateway 14 could, for example, add an advertisement to the bottom of the email. In such a scenario, if the email client sends out a response to the email, the advertisement may be deleted from the original email so that the recipient does not see the advertisement that was added by the gateway.

Features of existing firewalls and virus scanners can be used to implement some of the features of the gateway 14. Firewalls are intended to limit incoming and outgoing traffic according to certain rules. These rules may be based on source and destination IP addresses, source and destination port numbers, used protocol, and content of data packets. Rules can be combined and lead to quite complex behaviour of a firewall. These rules will result in actions like: reject packet, drop packet, forward packet, change IP addresses in packet and change port numbers in packet.

Sometimes several packets have to be put together and later disassembled in order to recognize a data flow or there must be some book-keeping to recognize a session and its matching packets.

For recognition and/or altering of packet content (in contrast to packet headers) so-called packet-inspection is applied. This requires knowledge of the used protocols and the structure of their packet formats. Packet inspection is also useful for virus detection.

In general, firewalls are applied to separate networks from each other and to control which traffic may cross the border between the networks. This is done very often at the border between local (“private”) networks and the open (“public”) internet. But also the borders between network segments within large organisations may be controlled by firewalls.

Although known firewalls and virus scanners can be used to inspect data packets passing through the firewall for potentially damaging code, such firewalls and virus scanners are not used to modify data packets, for example by modifying content provided by a server to an application.

Thus, existing firewalls can be used to inspect packets of data in accordance with the teachings of the present invention. Furthermore, existing firewalls can be modified to provide mechanisms for modifying data packets passing through the gateway 14, in accordance with the teachings of the present invention.

In one exemplary use of the gateway 14, a particular user may define types of data that he wishes to receive from a particular server and types of data that he does not wish to receive. This selection of data types may be provided to the server 16 or may be hidden from the server. Indeed, personalised content can be delivered from a server to the user, without the server needing to be aware of the identity of the user and/or any preferences set by the user.

Examples of data that a user may choose to accept or refuse include the following:
Blocking of in-site pop-up windows (e.g. AJAX windows)
Content filtering for mobile devices (e.g. image size reduction, compression of data)
Acceptance or refusal of the display of targeted advertising
General content filtering (e.g. for parental control or censorship purposes)
Spyware filtering and filtering tracking cookies (i.e. blocking spyware and cookies)
Policy based cookie filtering (e.g. IDM cookies may be allowed, whereas other cookies may be blocked).

Clearly, the list of data that a user may choose to block or to receive given above is not exhaustive. Many other examples will be readily apparent to persons skilled in the art.

The examples described above describe the use of the gateway 14 to enable a user to control data that should be allowed to pass through the gateway from the server to user. The invention is not limited to such arrangements. For example, the gateway 14 can be used to modify the data passing from the server to the application by adding new data. For example, the gateway 14 can readily be used to insert user-dependent advertising.

FIG. 4 shows a system, indicated generally by the reference numeral 70, that can be used for providing user-dependent advertising to a user. The system 70 comprises the application 12, gateway 14 and IDM 18 described above with reference to FIGS. 2 and 3. The database 20 of FIG. 2 may also be provided. The system 70 additionally comprises a content server 72 and an advertising server 74 in place of the server 16 described above. Once logged in, a user of the application 12 can obtain content from the content server 72 in the same way in which content can be obtained from the server 16 described above. This content may be provided by the server 16 without advertising and the gateway 14 can separately obtain suitable advertising from the advertising server 74. The advertising obtained from the advertising server 74 can, for example, be selected depending on options set by a user, or depending on information known to the gateway 14 about the user. The advertising selection may be based on other criteria in addition to, or instead of, data relating to the user of the application 12. By way of example, the advertising selected may be based on the time and date at which the data access is made, or on the location from which the request from the user is made.

An advantage of the present invention is that user-selected content options and other user-related data do not need to be provided to the server 16, the content server 72 or the advertising server 74. In this way, the content provided to the user can be tailored to the user concerned, whilst preserving the user's privacy. For example, in the system 70 described above with reference to FIG. 4, advertising provided to the user of the application 12 can be tailored to the user, without the content server 72 or the advertising server 74 being provided with any information about the user.

In the examples described above, the modification of data by the gateway 14 has largely been dependent on settings under the control of the user of the application 12. This is not an essential feature of the invention. By way of example, the modification of data may, at least in part, be dependent on requirements set by a third party. By way of example, parental control settings may enable a parent to determine the nature of content that a particular user can access via the gateway 14. In such a scenario, the parental control settings for a particular user may be stored at the IDM 18 and those settings applied when that user is identified by the IDM.

The gateway 14 may, for example, be located at the user's premises, in an access network operator's domain, or in a third party network. Similarly, the IDM 18 may, for example, be located at the user's premises, in an access network operator's domain, or in a third party network. Further, in some embodiments of the invention, the gateway 14 and the IDM 18 may be provide in the same location, but in other embodiments, the gateway 14 and the IDM 18 may be physically separated. For example, the gateway 14 may be located at the user's premises and the IDM 18 may be located in a third party network.

In the event that the gateway 14 is provided at the user's site (e.g. in an enterprise environment), the gateway may require that a user of the application 12 authenticates himself using the IDM 18 before that user is provided with full access rights. For example, the user may only be provided with Internet access following successful authentication. By doing so, the gateway 14 obtains full information regarding the identity of the user and is able to inspect and modify all information sent to the user in a user-specific manner.

In an alternative arrangement, the gateway 14 is provided at the same site as the server 16. In such an arrangement, the server 16 may require that a user of the application 12 be authenticated by the IDM 18 before full access to the server is given. For example, if the user is not authenticated, all services provided by the server 16 may be blocked; alternatively, the user may be prevented from obtaining personalised services. Again, once the user is authenticated, the gateway has full knowledge of the identity of the user and can inspect and modify data packets accordingly.

In one arrangement, the gateway 14 and the IDM 18 are separated. Although the IDM 18 can be operated at the user site or by the user's network operator (e.g. his mobile network operator), the gateway 14 may be associated with a server outside of the network operator's domain. In this case, the user must agree to forward his authentication to the server, which is equivalent to performing single-sign-on (SSO) at the server. Also, in this situation, the server 16 (and the associated gateway) knows the user's identity and may generate or adapt the content sent to the user.

In the embodiments of the invention described above, the server 16 has typically been a web server. This is not essential. The invention can be used in a wide variety of applications where content is delivered to a user via a gateway and that gateway is able to modify the data in some way depending on the identity of the user. For example, if the server 16 is an Internet protocol television (IPTV) server, the gateway 14 could, for example, add user-specific television content, such as advertisement videos, or advertisement overlays. Similarly, if the server 16 is an Internet radio server, the gateway 14 could, for example, add location-related news, or user-specific and/or location-specific radio advertisements.

The embodiments of the invention described above are illustrative rather than restrictive. It will be apparent to those skilled in the art that the above devices and methods may incorporate a number of modifications without departing from the general scope of the invention. It is intended to include all such modifications within the scope of the invention insofar as they fall within the scope of the appended claims.

We claim:

1. A method comprising:
receiving content from a server, which content is intended for an application;
modifying said content depending on the identity of a user of the application; and
forwarding the modified content to said application.

2. A method as claimed in claim 1, wherein said modifying step includes adding material to said content.

3. A method as claimed in claim 1 or claim 2, wherein said modifying step includes removing material from said content.

4. A method as claimed in any one of claims 1 to 3, further comprising determining the identity of the user of the application;

5. A method as claimed in claim 4, wherein the step of determining the identity of the user includes the use of an identity management system.

6. A method as claimed in claim 5, wherein the step of determining the identity of the user includes receiving credentials from the user and sending those credentials to the identity management system for verification.

7. A method as claimed in claim 5 or claim 6, wherein said modification step includes modifying said content in dependence on rules stored by said identity management system.

8. A method as claimed in any preceding claim, wherein said content is a web page.

9. A method as claimed in any preceding claim, wherein said content is Internet protocol television content.

10. An apparatus comprising:
a first input for receiving content from a server, which content is intended for an application;
a module for modifying said content depending on the identity of a user of said application; and
a first output for forwarding the modified content to said user.

11. An apparatus as claimed in claim 10, further comprising a module for identifying the user of said application.

12. An apparatus as claimed in claim 10 or claim 11, wherein the user of said application is identified using an identity management system.

13. An apparatus as claimed in any one of claims 10 to 12, further comprising a second input for receiving information identifying the user from the application.

14. An apparatus as claimed in any one of claims 10 to 13, wherein said module for modifying said content is adapted to add user-dependent material to said content.

15. An apparatus as claimed in any one of claims 10 to 14, wherein said module for modifying said content is adapted to remove material from said content.

16. An apparatus as claimed in any one of claims 10 to 15, wherein said apparatus is a gateway.

17. A computer program comprising:
code for receiving content from a server, which content is intended for an application;
code for modifying said content depending on the identity of a user of the application; and
code for forwarding the modified content to said application.

18. A computer program as claimed in claim 17, wherein the computer program is a computer program product comprising a computer-readable medium bearing computer program code embodied therein for use with a computer.
